(19) United States
(12) Patent Application Publication
(10) Pub. No.: US 2025/0278307 A1
(43) Pub. Date: Sep. 4, 2025

(54) REAL TIME DYNAMIC TEMPERATURE CONTROL IN AN INTEGRATED CIRCUIT HAVING MULTIPLE CPU CORES

(71) Applicant: DISH Network L.L.C., Englewood, CO (US)

(72) Inventor: Samuel Eber, Englewood, CO (US)

(21) Appl. No.: 19/064,363

(22) Filed: Feb. 26, 2025

Related U.S. Application Data
(60) Provisional application No. 63/560,533, filed on Mar. 1, 2024.

(51) Int. Cl. G06F 9/50

(52) U.S. Cl. CPC G06F 9/505

(57) ABSTRACT

A circuit and method are described for performing real time, dynamic temperature control of a microprocessor having multiple CPU cores. Steps are taken in order to maintain performance of the microprocessor at a high performance level while keeping the temperature of the microprocessor as a whole within a desired temperature range and lower than a top threshold temperature. A temperature sensor is positioned to sense the temperature of each core and a temperature control circuit outputs a temperature report signal to a system controller. The system controller of the CPU will receive the temperature report signal and the system controller will take steps on a real-time basis to provide dynamic allocation of the code to be run in each of the different cores in order to direct the operation of each respective CPU core to keep it from exceeding a top threshold temperature value.

### BACKGROUND

Integrated circuits, particularly a microprocessor with multiple CPU cores, generate significant heat when in operation. Avoiding excessive heat in the microprocessor will assist to extend its working life and promote uniform operation.

### BRIEF SUMMARY

A circuit and method are described for performing real time dynamic temperature control of a microprocessor having multiple CPU cores. Steps are taken in order to maintain performance of the microprocessor at its maximum performance capability while keeping the temperature of the microprocessor as a whole within a desired temperature range and lower than a top threshold temperature. A temperature sensor is positioned in each CPU core to sense the temperature of that core within the microprocessor. A temperature control circuit is coupled to the various temperature sensors and the temperature control circuit outputs a temperature report signal that provides data to a system controller regarding the current temperature of each of the cores in the CPU. The system controller of the CPU will receive the temperature report signal and then the system controller will take steps on a real-time basis to provide dynamic allocation of the code to be run in each of the different cores in order to direct the operation of each respective CPU core to keep it from exceeding a top threshold temperature value.

One way this can be done is by receiving an indication from the temperature control circuit that a particular CPU core has exceeded its top threshold value and then the system controller makes changes on a real-time basis to reduce the operational overhead of that particular core such as by reducing the clock speed, the number of machine instructions of the number of transistors operating within that particular CPU core, and transfer some of those tasks to a second CPU core that is below the top threshold temperature. Alternatively, the second CPU core to which the instructions are transferred can be one that has a second threshold temperature that is well below the top threshold temperature, for example the second threshold temperature can be set at a midrange that is halfway between a low threshold temperature and a top threshold temperature. Any CPU core on the microprocessor that is below the second threshold temperature can be selected to operate the code that has been rerouted from the first CPU core.

According to an embodiment, if one of the CPU cores is midway between the second threshold temperature and the top threshold temperature, the additional instructions are not sent to that CPU core but instead the system controller 20 will, based on input from the temperature control circuit 14, consider another core on the CPU that has a lower temperature. Steps are taken on a real time, dynamic basis to keep each core from exceeding the top threshold temperature.

There is at least one temperature sensor within each core. The number of temperature sensors within each core can be any selected number, whether one, two, three, or other number. Further, the temperature sensors can be put at particular locations within each CPU core whether in a central region, at an address buffer between the L1 and L2 cash, in the middle of an ALU within the CPU, or other location. A compiler in the system controller which will compile the source code into machine language code and will output the machine language code to run on a selected CPU core according to the instructions provided by the system controller. The system controller 12 has the capability to route the machine language code output by the compiler 16 to any one of the cores based on its temperature in order to maintain each of the cores at its preferred operating frequency and at its peak performance. Thus, each of the cores can be more fully utilized to keep any core from exceeding the top threshold temperature and preferably keep all the cores operating at their top level, near maximum clock frequency and performing the tasks which have been instructed by the source code input to the compiler.

A benefit is provided that the number of instances in which the clock frequency for particular core must be slow down in order to keep that core below a selected temperature is reduced.

### BRIEF DESCRIPTION OF THE DRAWINGS

FIG. 1 is a schematic block diagram of a multicore processor having real time dynamic temperature control according to an embodiment of the present disclosure.

FIG. 2 shows a schematic of one core of a multicore processor according to an embodiment.

FIG. 3 is a schematic block diagram of a multicore processor having real time dynamic temperature control according to an embodiment of the present disclosure.

FIG. 4 shows a flow diagram of a method for real time dynamic temperature control according to an embodiment of the present disclosure.

FIG. 5 shows a flow diagram of a method for real time dynamic temperature control according to an embodiment of the present disclosure.

FIG. 6 shows a flow diagram of a method for real time dynamic temperature control according to an embodiment of the present disclosure.

### DETAILED DESCRIPTION

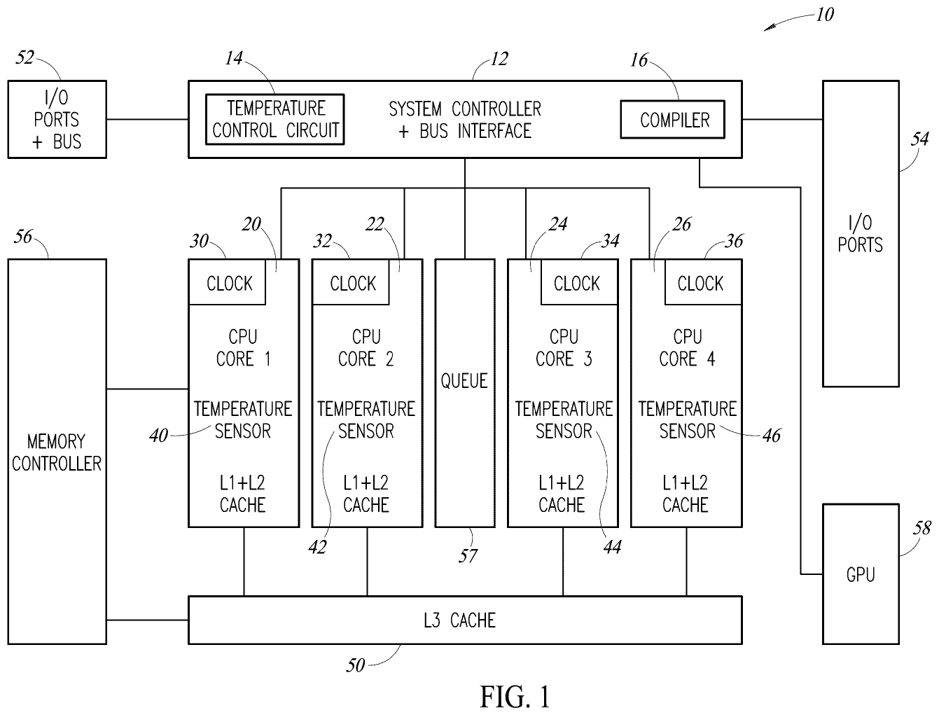

FIG. 1 shows a microprocessor 10 having the circuits and software to perform real-time dynamic temperature control of CPU cores. The microprocessor 10, as shown in FIG. 1, is on a single integrated circuit chip according to an embodiment; according to other embodiments, one or more circuits of the microprocessor 10 can be on two or more separate integrated circuit chips.

The microprocessor 10 includes a system controller and bus interface 12 as well as a temperature control circuit 14 and a compiler 16. According to an embodiment, the temperature control circuit 14 and compiler 16 are circuits within the system controller 12. In an alternative embodiment, the compiler 16 can be in a separate circuit different from the system controller 12; and in one embodiment, the compiler 16 can be on a separate integrated circuit chip.

The microprocessor 10 includes multiple CPU cores. In an embodiment, the microprocessor 10 includes four cores, namely a first core 20, a second core 22, a third core 24, and a fourth core 26. Each of the cores have their own respective clocks, the core 20 having a clock 30, the core 22 having a clock 32, the core 24 having a clock 34, and the core 26 having a clock 36. Each of the respective clocks in each respective core can drive the core at a selected frequency. The clock frequency for each core can vary as explained herein. Each core 20, 22, 24, 26 also includes a temperature sensor, respectively labeled 40, 42, 44, 46. Within each CPU core is also an L1 plus L2 cache. An L3 cache 50 is coupled to each of the CPU cores and acts as the main memory for the microprocessor 10.

The microprocessor 10 may also include various peripheral circuits, for example I/O ports plus bus 52, I/O ports 54, a memory controller 56, a queue 57, and a graphics processor unit (GPU) 58. It is not required that the microprocessor 10 include each of these additional peripheral circuits; for example, the microprocessor 10 may not include a queue 57 or perhaps a GPU 58. In addition, various microprocessors 10 may have significantly more peripheral circuits besides the CPU cores that make up the microprocessor 10.

According to the embodiment shown in FIG. 1, a temperature sensor is positioned in a central region of each respective core. Each CPU core has its own temperature sensor that will sense the temperature of the CPU core of which it is a part. Specifically, the temperature sensor is positioned in a central region of the core itself and as the temperature of the core increases or decreases, the temperature sensor reacts very quickly to the actual temperature of the core itself. Each CPU core will have a different temperature depending upon various factors associated with that particular core. Factors which tend to affect the temperature of the core include the clock frequency of the core itself at which it operates, the software being executed on the core, and the complexity of the machine code being executed, namely the number of transistors within the core there engaged in carrying out the instructions in each clock cycle. Depending on the instruction, a single clock cycle may engage 10% or 20% of the transistors within the CPU core. On the other hand, other instructions which are executed in a few clock cycles may engage 90% or more of the transistors in the core. As can be appreciated, an instruction which engages a large number of transistors in the core, for example in excess of 80 or 90% of the transistors, will cause greater heating of the core, and an instruction which engages fewer transistors, for example less than 10% or 20% of the transistors, will cause less heating of the core. The machine language code that is executed by the core might engage fewer or more transistors with each instruction which is executed by the core, and this will also affect the temperature of the core.

If the microprocessor becomes too hot, its performance will be degraded and it may stop operating correctly if it becomes too hot. In addition, if the microprocessor 10 operates at an excessive temperature for a long period of time, the operating life of the microprocessor 10 can be significantly shortened. It is, therefore, beneficial to keep each CPU core from exceeding a threshold temperature at which its performance will be degraded. It is known in the art today that slowing down the CPU clock frequency will reduce the speed and number of transistors operating within each core and, thus, will permit the core itself to cool down, as well as the entire chip on which the microprocessor 10 is located. Unfortunately, there is a significant decrease in performance if the CPU clock is slowed down in one or more CPU cores.

According to principles of the present disclosure, the machine code to be executed in each individual core is distributed to different cores, one or more of which might be running at a lower speed and one or more of which might be running at full speed, to provide an improved overall performance of the microprocessor 10 that is much higher than slowing down the clock speed of each core in the microprocessor 10.

There are number of ways to distribute the machine code to be run on the different cores so it can be redistributed to keep each core from exceeding a threshold temperature at which their performance degrades. Various techniques and circuits performing these techniques will be described herein.

As previously stated, running each respective clock 30, 32, 34, 36 at its highest possible frequency will cause each of the cores, and the entire microprocessor 10, to heat up. Additionally, if the instruction set is complex and is engaging many transistors in the core for each machine instruction, this will also cause heating. According to principles of the present disclosure, temperature feedback from each respective core is performed in order to provide dynamic, real-time targeting of specific cores to run the compiled machine code within the processor 10. Namely, a compile is done in the compiler 16 and a selection is made by the system controller 12 to send the machine code to specific cores for execution, sometimes to two or more different cores, depending on whether a particular core has exceeded a threshold temperature, is below a first threshold temperature, or is below a second threshold temperature.

According to principles of the present disclosure, the actual temperature of the silicon chip on which the microprocessor 10 is positioned is monitored in real time. As a core heats up, the temperature sensor within the core will provide a current and instantaneous signal of the temperature of the chip within that particular core at that location. The operation of each core is changed on a dynamic basis according to the heating in real time. Thus, a real time, dynamic temperature control of the microprocessor 10 as a whole is achieved.

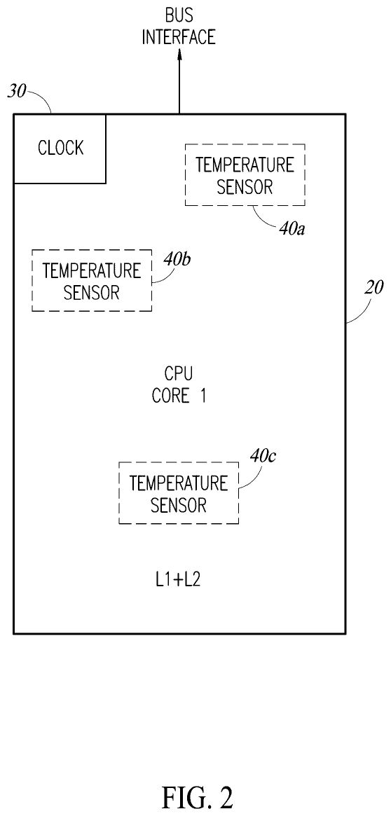

FIG. 2 provides another example of the potential design of a CPU core according to principles disclosed herein. In this example, the CPU core 20 is represented in FIG. 2 as the first core of the microprocessor 10 of FIG. 1, but the teachings can be applied to any core within the microprocessor 10. In an embodiment, the CPU core 20 can have two, three or more temperature sensors 40 positioned therein. For example, a first temperature sensor 40a, a second temperature sensor 40b, and a third temperature sensor 40c can be positioned at different locations within the CPU core 20. In addition, the clock 30 is provided for the CPU core. As will be appreciated, the clock 30 may not itself be part of the CPU core 20; instead, some of the clock circuitry as well as a crystal and other clock driving circuits may be located in the peripheral circuits of the microprocessor 10. Having the clock 30 in the core is shown for schematic purposes only for understanding that a clock will drive the CPU core 20. As will be appreciated, inputs from the clock will enter the CPU core 20 at many different locations and much if not all of the clock circuitry itself will be positioned outside of the CPU core. The location and clocking circuitry for a CPU core is well known to those of skill in the art and need not be described herein. The general principles well known for clocking a CPU core are used in the present disclosure.

The location of each of the temperature sensors 40a, 40b, 40c can be selected in order to provide good temperature sensing, as well as temperature prediction of temperature changes that may be expected in the core. For example, one temperature sensor 40a may be placed in a part of the CPU core which is always active and when any part of the processor is being driven by the clock that is running, this part of the core will be engaged in the transistors in operation and outputting heat. If only a portion of the core 20 begins to heat up, then the thermal effects can spread to other parts of the microprocessor as well as a substrate cooler so the CPU core 20 itself does not begin to overheat. Thus, the temperature sensor 40a can be placed in a predictive location which, when it heats up, could provide an indication that other parts of the core will soon heat up. The temperature sensor 40a can be placed in computational intense part of the CPU core 20, for example, the middle of an ALU. In the event the majority of the transistors in the CPU core are engaged in carrying out intensive instructions, then increases in temperature will be sensed by temperature sensor 40b, which is in a region of the core 20 at which rapid heating occur. A temperature sensor 40c, is in a third region of the core 20. For example, the temperature sensor 40c may be located in an address buffer or at the interface between the CPU processors that include the various ALUs and the caches L1 and L2. Alternatively, the temperature sensor 40c can be located in the center of the L1 cache and, thus, be very sensitive to frequent memory usage and heating that might be caused by a large number of rapid memory access instructions to the L1 memory. As will be appreciated, some instructions operated by the CPU core will include heavy computation to be carried out by ALUs having densely packed transistor use within the core 20, while other functions to be carried out may include fewer transistors, for example memory exchanges between the L2 and L3 memories. The more transistors engaged in each clock cycle the more heating will occur and the CPU core 20 will begin to heat up. Having temperature sensors at three or more locations within the CPU core 20 provides more accurate measurement of the current temperature and rapid response rate changes in temperature that may occur in the CPU core as a whole.

As just one example, the first temperature sensor 40a may reach a threshold temperature which is determined to be higher than a desired operating temperature for the core 20. However, by sensing the temperature reading from temperature sensor 40b or 40c, the system becomes aware that the core 20 as a whole has not exceeded the threshold temperature and the heat will dissipate through the rest of the core and, therefore, the threshold temperature of the core as a whole will not be indicated as having been exceeded. As the CPU core 20 continues to operate, the temperature sensed by temperature sensor 40b and/or 40c may also begin to rise and may exceed the threshold temperature. If the temperature of all three sensors 40a, 40b, 40c exceeds the threshold temperature, then the temperature control circuit 14 as shown in FIG. 1 can indicate that the core as a whole has exceeded the threshold temperature and steps need to be taken to reduce the temperature of the core below the threshold value.

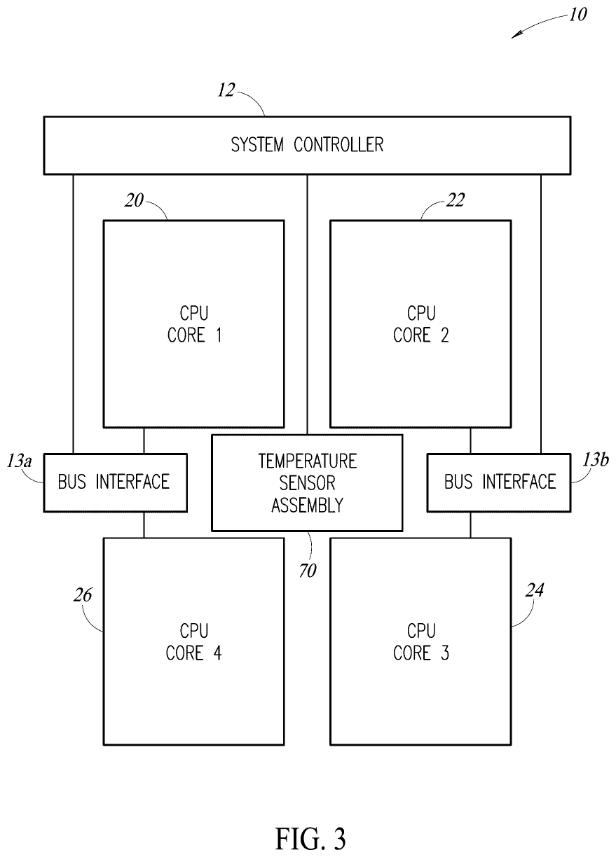

FIG. 3 provides another embodiment of another microprocessor 10 designed according to principles of the present disclosure. Similar to FIG. 1, the microprocessor 10 of FIG. 3 includes a system controller 12 and CPU cores 20, 22, 24, 26. In this particular design, bus interface circuits 13a and 13b are separated from each other and isolated from the system controller 12. Accordingly, the bus interface may be a separate circuit 13 rather than integrated near the system controller 12. In this particular design of the microprocessor 10, as shown in FIG. 3, a single temperature sensor circuit assembly 70 is positioned in a central region the microprocessor 10. This temperature sensor assembly 70 may be comprised of a number of different embodiments. According to an embodiment, the temperature sensor assembly 70 in the central region of the microprocessor 10 includes all the temperature sensor circuitry as well as the temperature control circuitry 14 from FIG. 1 and the various temperature sensors 40, 42, 44, 46. This provides a compact design for the various temperature sensors. A single temperature sensor can be located adjacent to CPU core 20, another temperature sensor located adjacent to CPU core 22, another temperature sensor located adjacent to CPU core 24, and another temperature sensor located adjacent to CPU core 26.

As will be appreciated, as one of the CPU cores begins to heat up, the heat will begin to dissipate towards other regions of the chip, mostly towards a central region. Accordingly, having a temperature sensor near the central region, adjacent to a CPU core will be able to provide a sufficiently accurate report of the temperature of each respective core. In the design of FIG. 3, the temperature sensors themselves are not within the CPU cores, but rather are located in physically different positions just outside of the core itself. In addition, the control circuitry to take action based on the temperatures being sensed from each of the respective cores 20, 22, 24, 26 is also within the temperature sensor circuit assembly 70. Signals can be sent to the system controller 12 in order to control the different parts of the microprocessor 10 in coordination with each other in order to smooth out the temperature based on changing the load in each of the respective CPUs. The particular design of each core might not permit a temperature sensor to be also within the core. Namely, the transistors in the core might need to be connected in a way that having a temperature sensor positioned in the middle of them might not be practical or might increase the size or speed of the core. Thus, the design of FIG. 3 can be used to place the temperate sensor just outside the core itself.

It is also possible to have 2, 3, 4 or more temperature sensors positioned around the periphery of each core. One can be on each of the top and bottom and/or on each left and right side. Thus multiple temperature sensors can be used in the design of FIG. 3 with each one outside the core following the principles explained with respect to FIG. 2.

As can be appreciated, each of the CPU cores 20, 22, 24, 26 have a clock driving circuit and are driven on clock cycles based on the frequency of the respective clock, but this is not shown for the sake of simplicity, particularly since clock driving circuits and controlling their frequencies are well known in the art. Any method of driving each respective CPU core 20, 22, 24, 26 with its individual clock and change in the frequency of each CPU core may be used, many of which are known in the art.

The type of temperature sensors used in the embodiments of FIGS. 1-3 can be any acceptable type that is compatible with the semiconductor processes used to make the microprocessor 10. If there is a single temperature sensor 40 within the CPU core 20 as shown in FIG. 1, this could be a simple resistor circuit. The design may be one having just one transistor that provides feedback regarding the temperature at its location. Alternatively, a more complex circuit can be provided, such as one which includes an amplifier, a comparator, internal feedback circuits, one or more resistors, and additional transistors and circuits to obtain an exact temperature sense, as well as control for any feedback signals. If three temperature sensors are within a core as shown in FIG. 2, these could be any type of acceptable temperature sensing circuits using a combination of transistors, resistors, comparators, amplifiers or various feedback circuits in order to obtain an accurate measure of the temperature at the exact location in the semiconductor chip at which the temperature sensor is positioned. These could be relatively small circuits comprised of one or two transistors, or somewhat more complex including several transistors, amplifiers, and various control circuits in order to obtain a very accurate measurement of the exact temperature at the location in which the sensor is placed. As yet a further alternative, the temperature sensor may be a Wheatstone bridge of a design that is well known in the art. A Wheatstone bridge type of sensor may be particularly beneficial for the embodiment of FIG. 3 in which all temperature sensors are in a separate physical location spaced outside each respective CPU core. The four temperature sensors within the temperature sensor assembly 70 may each be a separate Wheatstone bridge and the output is provided to a central temperature control circuit within the temperature sensor assembly 70. Alternatively, there may be some sharing of components within the various Wheatstone bridges which make up the temperature sensor for each of the four CPU cores 20, 22, 24, 26. As previously stated, temperature sensors per se for determining the temperature within a chip at the location of the temperature sensor itself are well known in the art, and dozens of different designs are available. Any acceptable temperature sensor may be used that is compatible with the processor and provides a sufficiently accurate reading that the temperature of the core can be known.

It is also within the potential design to use a combination of the various temperature sensors as shown in FIGS. 1-3. For example, a single core may have two or more temperature sensors therein placed at different locations within the core based on which transistors are more likely to output significant amounts of heat. In addition, a temperature sensor assembly 70 may be positioned in a central region of the integrated circuit chip on which the microprocessor 10 is formed so that a temperature measurement is provided within each core either at a single location or multiple locations and, in addition, a temperature measurement is provided for each core at a location just outside of the core itself to provide an indication of how much of the core heat is being spread to other portions of the integrated circuit chip.

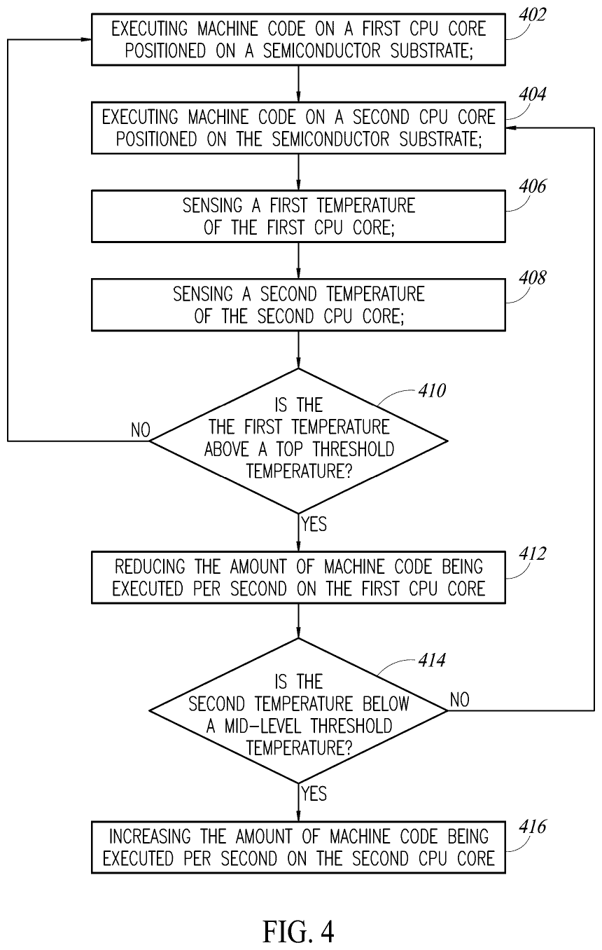

As an example of operation of the circuit according to principles of the present disclosure, flowcharts of FIGS. 4-6 will now be described and these teachings can be applied to the CPU core 20, as well as to the CPU core 22 and any other combination of cores. The description will be of just two cores for simplicity, but the principles as taught herein can be applied to a microprocessor having two cores, four cores, eight cores, 16 cores, or any combination of CPU cores.

A particular microprocessor 10 will have a desired optimum operating temperature range and will also have a top threshold temperature above which it should not be operated. According to some designs, a range between 70° and 90° C. is a preferred operating temperature for the microprocessor 10 as a whole and each individual CPU core may operate at temperatures in the 90° to 100° C. range. However, if any core 20 exceeds some safe threshold operating temperature, for example 110° C., 120° C., or some other value that is a top threshold temperature for a permissible high operating range for that core, then steps are taken to keep the CPU core 20 from going above this threshold temperature. As can be appreciated, the safe top threshold temperature may vary for different CPU cores and for different microprocessors. In some systems, a temperature of 80° C. will be considered a maximum operating temperature and will be the top threshold temperature that triggers steps to be taken to keep the core from becoming hotter, while in other microprocessors 10, the temperature may be about 50° C., 60° C., 70° C., 110° C. or any value based on the integrated circuit chip design and the processes being used, including any heatsinks that may be associated with that particular microprocessor that would permit the heat to dissipate quickly. Most microprocessors are able to safely operate at about 80° C.; however, most have a maximum operating temperature somewhere in the range between 90° C. and 110° C. that is common.

A number of different threshold temperatures can be established for each particular microprocessor 10. For example, a maximum threshold operating temperature can be established as a top threshold which if exceeded would cause steps to be taken to reduce the operation of the microprocessor 10, even though it will reduce its performance in order to keep it within a stable and safe operating range. Another mid-level threshold temperature can be established which is somewhat less than the maximum threshold operating range. For example, a second threshold temperature can be established at which the clock frequency would be slowed down from one or more of the CPU cores in order to keep the CPU cores from becoming hotter, but they will still maintain reasonable operation at a reasonable clock speed in order to continue to complete the tasks of the executed software. A third threshold temperature can be established which is considered a safe operating range at which there is substantial margin for additional heating. For example, a low threshold temperature in the range of 25° to 40° C. may be established in which it is known that the CPU core is performing very few tasks and can be run at a higher clock speed and/or receive more tasks and still stay safely below the top threshold temperature operating range. Thus, one of the threshold temperatures may be a low threshold temperature which provides an indication to the system that the core 20 is available to perform tasks and can accept substantial additional heating and still stay below the top threshold temperature operating value. Knowing that one CPU core is below the low threshold temperature has significant benefits according to an embodiment of the present disclosure as will be described.

Viewing FIG. 4, the system begins to execute machine code in a first CPU core on a semiconductor chip substrate as set forth in step 402. In addition, machine code is executed on a second CPU core that is positioned at a different location on the same semiconductor chip substrate step 404. As the machine code instructions are carried out in the various CPU cores, the temperatures of the cores are sensed on a continuous or near continuous basis. The temperature of the first core is sensed in step 406 and the temperature of the second core is sensed in step 408. These four steps continue to be carried out on a continuous or near continuous basis according to the instructions provided to each of the CPU cores. As will be appreciated, source code is provided to the system controller 12 which has a compiler 16 associated with it, either positioned within the system controller 12 itself or positioned at a location outside of the system controller, providing a compiling of the source code and outputting the source code as machine language code that can be operated by each of the respective CPU cores.

The compiler 16, and often the program which is being run on the microprocessor 10, may be optimized in order to perform the desired function as quickly as possible and to maximize the output of the computed data and the completion of particular tasks. As can be appreciated, if a single CPU core is performing all of the instructions that are associated with one particular task, then that task can be completed more quickly. The compiler 16 may prefer to send the machine language instructions just to a single CPU core 20 to have all computation for that task will occur within that single core 20. This single core 20 can have direct interaction with the system controller in order to receive instructions to be carried out, to carry out those instructions, complete the task, and provide the requested information and data as an output. Thus, if the goal is to have rapid execution of a task, then sending instructions by the compiler to just a single CPU core for all parts of that same task is preferred. The compiler may be organized to carry out the tasks in such a fashion and, therefore, provide a large number of instructions to just one core only while the other cores remain somewhat less used for any particular task. This would cause one core 20 to rapidly overheat while the other cores 22, 24, 26 remain well below the threshold temperature of overheating.

The temperature of the first CPU core 20 is monitored in step 410 where the query is asked if the temperature of the core 20 is above a threshold temperature that has been established as a safe operating temperature for the core 20. If the answer is that the temperature is not above the threshold temperature in step 410 then the process continues to step 402 as indicated in FIG. 4. On the other hand, if the temperature of the core 20 is at or above the threshold temperature which has been set as a top threshold temperature, then the query in step 410 returns yes and the amount of machine code being executed by the CPU core 20 is reduced in step 412. According to principles of the present disclosure, it is desired to continue performance of the tasks without degrading the speed at which each task is being performed and maintain efficient operation of the microprocessor 10. Accordingly, after the amount of machine code being executed in the step 412 has been reduced for core 20, the compiler 16 is alerted to this change by the temperature control circuit 14 and the compiler 16 then sends the machine language code that would have been run in core 20 to a different core, such as core 22 or core 24. In order to determine which core to send the instructions to, the temperature of each of the other cores is being sensed as described with respect to step 406. In step 414 the core is asked is whether the temperature of the second core 22 is below a selected threshold temperature, usually a low threshold temperature. If the answer is yes, then the amount of machine code being executed per second in the second CPU core is increased in step 416. In particular, the code that would have been run in the first core 20 is reallocated by the system controller 12 in coordination with the temperature control circuit 14 and the compiler 16 in order to send code for the task being performed by core 20 to a different core, such as the core 22, 24, or 26, depending on a preferred core and its temperature to assist in completing the task.

There are number of techniques that can be carried out to reduce the amount of machine code being executed per second on a particular CPU core as set forth in step 412. One of the easiest techniques is to slow down the clock speed of that particular CPU core. Accordingly, a first step that can be taken is to reduce the clock speed of the CPU core 20 and then maintain the clock speed of the CPU core 22 at the same speed or potentially increase the clock speed so that is able to carry out more instructions per second. Thus, controlling the frequency of the clock is one of the effective ways to reduce or increase the amount of machine code being executed per second within a CPU core and, thus, reduce its temperature because there will be less heating caused by the operation of the transistors therein at slower speed. Another technique is to bypass a particular core. As will be appreciated, there are some types of instructions which make very heavy use of an Arithmetic Logic Unit (ALU) within a particular CPU that performs significant computational chores. This will engage most if not all of the transistors within a core and cause significant heating of the core. If more transistors are being switched, then that amount of machine code being executed is increased. In this context, the meaning of “amount of machine code being executed per second” includes involving more transistors in each clock cycle of the instruction set. Some instructions will involve a large number of transistors in the core, while other instructions or other tasks may only use a portion of the transistors within a core, for example 10% or 20% and may be engaged primarily in easier functions. If the instruction is a simple memory exchange between L1 and L3, this may not require activation of the majority of the transistors within a core. Thus, a second way for reducing the amount of machine code is to keep the clock rate the same, but change the instructions being carried out by each core so that the number of transistors activated is fewer and, thus, the heating by the core is reduced. As can be appreciated, the operation and switching of the transistors is a primary cause of the heating of the core, and if more transistors are used per instruction and are switching more rapidly, then the core will heat up more rapidly. On the other hand, if the switching speed of the transistors is reduced then the heating will be reduced and, in the alternative if fewer transistors are being switched on and off in a single clock cycle, then the heating will also reduce. Additionally, if the task being carried out relies on a large number of transistors being held off for a large part of the task or a large number of transistors being on for the task and there is not a large amount of switching of a majority of the transistors in a core. Many circuits generate heat based on the switching of the transistors and if the transistor is in a steady-state on or off condition then the heat generated may be less. Thus, changing the type of task being carried out by the core 20 will also have the effective of reducing the amount of machine code being executed per second in step 412, namely result in less heating by fewer transistors outputting large amounts of heat.

Accordingly, there are a number of techniques by which the amount of machine code being executed in a particular core can be reduced. This would correspond to reducing the number of transistors that are being operated within a particular core. The meaning of reducing the amount of machine code is understood in its broadest concept to include any technique that will reduce the number of transistors operating over a given time period, the speed at which they operate, the switching characteristics, or any other changes that will reduce the heat generated by circuit operation within a particular core.

According to an embodiment, when the temperature control circuit 14 sees that a particular core is becoming too hot, it can send a temperature report signal to the system controller and the system controller can take steps to bring the core back within an acceptable temperature range. For example it can slow the clock down, instruct the compiler to send different tasks to that particular core, or take other steps to reduce the temperature of that core. At the same sequence of steps, it can then speed up another core within the same microprocessor 10 in order to pick up and carry the same tasks. Smart logic can be used within the controller 12 in coordination with the compiler 16 in order to redirect the tasks to one of the cores 22, 24 which is at or below the second threshold temperature range. Accordingly, the temperature of all the cores is being sensed, and when one core begins to heat up then the system selects a core that has a temperature that is below a low threshold temperature, for example 60° C. or lower, and distributes the code to the cooler core. The clock speed can then be increased or steps can be taken to redirect the operation of more transistors by sending more or different machine code to that particular core to keep the core at full operating conditions just below the acceptable threshold temperature. Thus, the clock speed can be slow down briefly at the core 20 and then, after some of the tasks are being carried out by the CPU cores, the clock speed can be slightly increased or, in some instances, brought back up to the full speed as other cores begin to perform the tasks that have been carried out or would have been carried out by the CPU core 20.

According to an embodiment, a possible option is to have predictive temperature logic that senses current temperature data of each core and sends the temperature data to the system controller 12 and the compiler 16, and then the code is directed to the particular core that is within the threshold temperature and the other tasks are distributed by the compiler 16 to the different cores to keep all the cores from exceeding a threshold temperature.

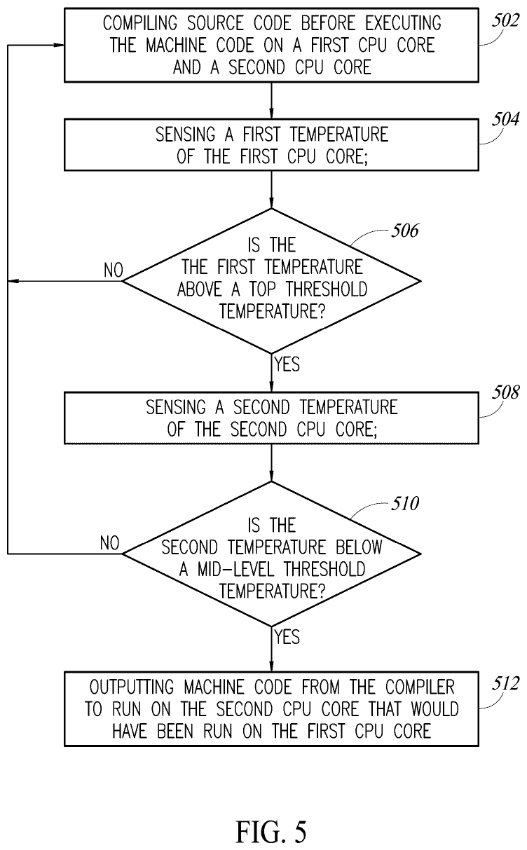

FIG. 5 provides an alternative embodiment for selecting a core in which the instructions are to be carried out prior to sending the instructions. In step 502, the compiler 16 compiles the source code before executing the machine code in a first CPU core 20 or second CPU core 22. In step 504, a temperature is sensed of the first CPU core 20. In step 506, a query is made whether or not the first CPU core is below or above a selected temperature. This selected temperature may be a midpoint selected temperature, below the maximum threshold temperature. For example, it may be 20% or 30% lower than a maximum acceptable threshold temperature. If the answer in step 506 is that the temperature of the first core is not above a selected threshold temperature, then the compiling continues and may output the machine code from the compiler 16 to run on the first CPU core 20. Namely, if the temperature of the desired core for carrying out the machine instructions is below a second threshold, for example a mid-level threshold temperature, then this sensing is performed before the code is sent to the core, and if it is below the temperature then the code is sent to the core. On the other hand, if it is above this selected temperature, then a temperature is obtained of a second CPU core 22 in step 508. If the second CPU core 22 is below a selected threshold as the query in step 510, then the machine code is output from the compiler to run on the second CPU core 22 in step 512 that would have otherwise been run on the first CPU core 20. On the other hand, if the temperature of the second CPU core is above the selected threshold, then a no is returned and the response is made to the system controller 12 so that the compiler 16 can then send the code to yet a third or fourth core 24, 26 to be executed which are within a desired operating range at the time the code is going to be sent.

According to the technique of FIG. 5, the temperature is sensed just prior to the code being sent, and a dynamic selection is made as to which core is to receive the instruction sets to be carried out. If the core is above a second selected threshold that is approaching a top threshold temperature, then it can be expected that sending additional instructions to it will cause it to reach the top threshold temperature which would result in the system being slowed down or the step to be made degrading the performance of that particular CPU core. Thus, in order to avoid reducing the performance of that particular CPU core, the instruction sets are sent to different CPU core that is below a midrange threshold temperature so that each of the cores can be kept within a desired operating temperature range and none of the cores reaches the top threshold temperature. This routing of the code is made on a dynamic basis in order to provide real time temperature control on a dynamic basis of the microprocessor while in many instances maintaining the performance at its highest possible level.

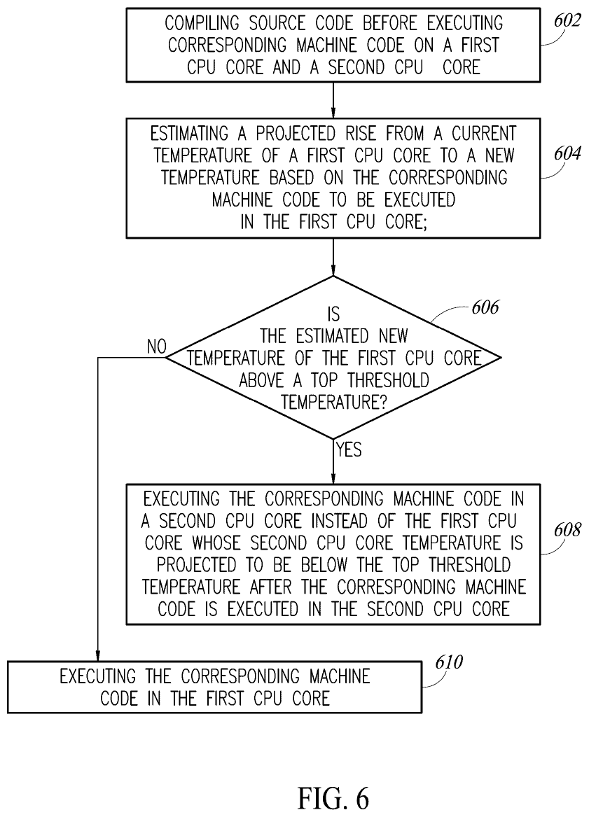

FIG. 6 shows yet another potential embodiment according to further principles as described herein. According to the embodiment of FIG. 6, an estimation is made of a projected rise in temperature if the additional machine language code is sent to a particular core. In the alternative embodiment of FIG. 6, the source code is compiled in the compiler 16 that will be executed as machine language code in one or more of the CPU cores of the microprocessor 10 as set forth in step 602. While the compiler is compiling the code or just prior to the compiler beginning the operation of doing the compile, the system controller 12 receives signals from the temperature control circuit 14. The temperature control circuit 14 provides to the system controller 12 the current temperature of each of the cores. The system controller 12 also has information regarding the particular task to be carried out by the program code that is about to be executed on the respective cores. The system controller 12, since it knows the code about to be run, will have information to indicate the type of task to be carried out, whether it is a task which is highly intensive computation which will cause many transistors be operated or whether it is a task of low computation and/or not many transistors will be engaged. Or perhaps the task is simply a number of memory location exchange tasks which do not involve many of the transistors in the core. For example, it may just be operations of swapping data between the L1, L2, and L3 caches. Such data swaps do not use as many transistors as a heavy graphics or computational task and will not cause as many transistors to operate as a computationally intensive operation carried out in the core. Accordingly, the system controller 12 will estimate a projected rise of temperature in a particular CPU core in step 604 to estimate a new temperature based on the content of the machine code to be executed in the particular CPU core. Using this projected estimate, a projection will be made whether or not the estimated new temperature will cause the CPU core to which the machine code is targeted to be sent to exceed the top threshold operating range in step 606. In particular, if the estimated new temperature of the CPU core 20 will be above a top threshold temperature if the code is executed therein, then a yes is output by the step 606 and the corresponding machine code is executed on a second CPU core 22 in step 608 instead of being executed in the first CPU core 20. The second CPU core 22 will be selected to have a temperature that is projected to remain below the top threshold temperature after the corresponding machine code is executed in the second CPU core 22. On the other hand, if the estimated new temperature that is projected for the first CPU core 20 is going to be below the top threshold temperature, then the code is executed in the first CPU core 20 as indicated by step 610.

A number of techniques have been described herein in order to maintain performance of the microprocessor 10 at near its maximum capability while keeping the temperature of the microprocessor 10 as a whole within a desired temperature range and lower than a top threshold temperature. This is realized by having temperature sensors positioned to sense the temperature of each core within the CPU. A temperature control circuit is coupled to the various temperature sensors and the temperature control circuit outputs a temperature report signal that provides data regarding the current temperature of each of the cores in the CPU. A system controller of the CPU will receive the temperature report signal and then the system controller will take steps on a real-time basis in a dynamic allocation in order to modify the operation of the respective CPUs in each core to keep it from exceeding a top threshold value. This can be done by receiving an indication from the temperature control circuit that a particular CPU core has exceeded its top threshold value and changes must be made on a real-time basis to reduce the operational overhead such as by reducing the clock speed, the number of machine instructions of the number below of transistors operating within the first CPU core, and transfer some of those tasks to another CPU core that is below the top threshold data. Alternatively, the CPU core to which the instructions are transferred can be one that has a second threshold temperature that is well below the top threshold temperature, for example the second threshold temperature can be set at a midrange that is halfway between the low temperature and a top temperature, and any CPU core that is below the second threshold temperature can be selected to operate the code that has been rerouted from the first CPU core. However, if one of the CPU cores is midway between the second threshold temperature in the top threshold temperature then the additional instructions are not sent to that CPU core, but instead the system controller 20 will receive input from the temperature control circuit 14 and look at another core on the CPU core which has the mid-level threshold value so that steps are taken on a dynamic basis to keep the second core from exceeding the top threshold temperature.

The number of temperature sensors within each core can be any selected number, whether one, two, three, or other number. Further, the temperature sensors can be put at particular locations within each CPU core whether in a central region, at an address buffer between the L1 and L2 cash, in the middle of an ALU within the CPU, or other location. A compiler is provided which will compile the source code to machine language code and output the machine language code to run on a selected CPU according to the instructions provided by the system controller 12. The system controller 12 has the capability to route the machine language code output by the compiler 16 to any one of the cores based on its temperature in order to maintain each of the cores at its maximum possible operating frequency and at its peak performance. Thus, each of the cores can be more fully utilized to keep any core from exceeding the top threshold temperature and preferably keep all the cores operating at their maximum clock frequency and performing the tasks which have been instructed by the source code input to the compiler 16.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A microprocessor on an integrated circuit, comprising:
a substrate;
a plurality of CPU cores on the substrate including a first CPU core and a second CPU core;
a first temperature sensor positioned to sense a temperature of the first CPU core;
a second temperature sensor positioned to sense a temperature of the second CPU core;
a temperature control circuit coupled to the first and second temperature sensors, the temperature control circuit outputting a temperature report signal having data regarding a current temperature of the first and second CPU cores; and
a system controller configured to receive the temperature report signal, the system controller being configured to modify operation of both the first CPU core and the second CPU core if the temperature report signal exceeds a first threshold value for the first CPU core and does not exceed a second threshold value for the second CPU core.

2. The microprocessor of claim 1 wherein the first temperature sensor is within a central region of the first CPU core.

3. The microprocessor of claim 1 wherein the first temperature sensor is positioned outside of and adjacent to the first CPU core.

4. The microprocessor of claim 2 wherein the first temperature sensor includes at least one transistor and one resistor.

5. The microprocessor of claim 1, further including:
a third temperature sensor positioned within a central region of the first CPU core and spaced from the first temperature sensor.

6. The microprocessor of claim 1, further including:
a compiler configured to receive source code to be executed on the first and second CPU cores and output machine code to be run on the first and second CPU cores.

7. The microprocessor of claim 6 wherein the compiler is located on the same integrated circuit as the first and second CPU cores and is positioned within the system controller.

8. The microprocessor of claim 6 wherein the compiler is located on a different integrated circuit than the first and second CPU cores.

9. The microprocessor of claim 6 wherein the compiler receives the temperature report signal and directs machine code that would have been sent to run on the first CPU core to instead be sent to run on the second CPU core if the temperature of the first CPU core is above the first threshold value.

10. The microprocessor of claim 6, further including:
a temperature prediction circuit coupled to the compiler, the temperature prediction circuit being configured to estimate whether there is expected to be an increase in temperature that will exceed the first threshold value of the first CPU core if code that is in a queue to be sent to the first CPU core is executed by the first CPU core.

11. The microprocessor of claim 1 wherein the first threshold value and the second threshold value are different from each other.

12. A method of controlling a temperature of an integrated circuit, comprising;
executing machine code on a first CPU core positioned on a semiconductor substrate;
executing machine code on a second CPU core positioned on the semiconductor substrate;
sensing a first temperature of the first CPU core;
sensing a second temperature of the second CPU core;
comparing the first and second temperatures to a threshold temperature in a system controller on the integrated circuit;
reducing the amount of machine code being executed per second on the first CPU core if the first temperature is above the threshold temperature; and
increasing the amount of machine code being executed per second on the second CPU core if the second temperature is below the threshold temperature and the first temperature is above the threshold temperature.

13. The method of claim 12 wherein the increased amount of machine code that is to be executed on the second CPU core had previously been allocated to be executed on the first CPU core.

14. The method of claim 12, further including:
maintaining a clock speed of the first CPU core at the same rate after the amount of machine code being executed thereon has been reduced.

15. The method of claim 12, further including:
reducing a clock speed of the first CPU core after the amount of machine code being executed thereon has been reduced; and
maintaining the clock speed of the second CPU core at the same rate after the amount of machine code being executed thereon has been increased.

16. The method of claim 12, further including:
increasing a clock speed of the second CPU core after the amount of machine code being executed thereon has been increased.

17. The method of claim 12, further including:
compiling source code in a compiler before executing the corresponding machine code on the first CPU core and the second CPU core; and
outputting machine code from the compiler to run on the second CPU core that would have run more efficiently on the first CPU core based on having received first and second temperatures of the first and second CPU cores.

18. The method of claim 17, further including:
estimating a projected rise in current temperature of the first CPU core to be a new temperature based on machine code planned to be executed in the first CPU core;
determining that the estimated new temperature of the first CPU core, if the planned machine code is executed, will exceed the threshold temperature; and
executing the planned machine code on the second CPU core instead of the first CPU core, whose temperature is projected to be below the threshold temperature after the planned machine code is executed in it.

19. The method of claim 12, wherein the threshold temperature is a first threshold temperature, the method further including:
comparing the first and second temperatures to a second threshold temperature in a system controller on the integrated circuit, the second threshold temperature being lower than the first threshold temperature;
increasing a clock speed of the first CPU core if the temperature of the first CPU core is below the second threshold temperature;
maintaining the clock speed of the first CPU core the same if the temperature of the first CPU core is above the second threshold temperature and below the first threshold temperature; and
reducing the clock speed of the first CPU core if the temperature of the first CPU core is above the first threshold temperature.
